(19) United States
(12) Patent Application Publication
(10) Pub. No.: US 2006/0226635 A1
(43) Pub. Date: Oct. 12, 2006

(54) Platform mounting arrangement for baby stroller

(76) Inventor: Mien Chen Huang, Tainan (TW)

Correspondence Address: Keith Kline;PRO-TECHTOR INTERNATIONAL SERVICES, 20775 Norada Court, Saratoga, CA, 95070-3018, US

(21) Appl. No.: 11/104,965

(22) Filed: Apr. 12, 2005

(51) Int. Cl. B62B 1/00

(52) U.S. Cl. 280/642

(57) ABSTRACT

A platform mounting arrangement used in a baby stroller is disclosed to include comprises an upper bracket fixedly fastened to the rear side of the seat frame of the baby stroller and suspending between two opposite lateral sides of the seat frame, a bottom bracket fixedly fastened to the rear wheel frame unit of the baby stroller, a swinging frame pivotally coupled to the rear wheel frame of the baby stroller, and a pivotally connected to the swinging frame and turnable with the swinging frame between a first position supportable on the bottom bracket for the standing of a child and a second position supportable on the upper bracket for the sitting of a child.

### BACKGROUND OF THE INVENTION

1. Field of the Invention

The present invention relates to a baby stroller and more particularly, to a platform mounting arrangement for baby stroller, which provides a footplate that can be selectively set between a first position for the standing of a child and a second position for the sitting of a child.

2. Description of the Related Art

A baby stroller may be provided with a footplate or platform for the standing of a child. The footplate or platform may be fixedly or detachably fastened to the frame structure of the baby stroller. Similar designs are invented in U.S. Pat. Nos. 5,622,375; 5,664,795; 6,530,591. According to U.S. Pat. No. 5,622,375, a transverse platform is provided at its lower rear, with the rear wheels mounted substantially at the trailing edge of the platform. The seat is forward of the platform, so that a second child can be carried on the platform, in a standing position behind the seat. Alternatively, a shopping bag can be carried vertically on the platform. According to U.S. Pat. No. 5,664,795, a double-seat stroller is disclosed to comprise a back plate disposed at the middle portion of the basket frame thereof and a back seat plate is disposed beneath the back plate. According to U.S. Pat. No. 6,530,591, a frame structure for baby stroller is constructed to include a rear seat frame bar adapted to support a rear seat, a front seat frame adapted to support a front seat, the front seat frame supporting a footplate for the standing of a child behind the rear seat frame bar. The aforesaid various prior designs commonly have a complicated structure, resulting in a high manufacturing cost.

### SUMMARY OF THE INVENTION

The present invention has been accomplished under the circumstances in. It is one object of the present invention to provide a platform mounting arrangement for baby stroller, which comprises a footplate that can be selectively set between a first position for the standing of a child and a second position for the sitting of a child. To achieve this and other objects of the present invention, the platform mounting structure is installed in a frame structure for baby stroller, which a front wheel frame unit, a rear wheel frame unit, a seat frame, a handlebar, two front wheels, two rear wheels, and two sidebars. The platform mounting arrangement comprises an upper bracket, a bottom bracket, a swinging frame, and a footplate. The upper bracket is fixedly fastened to the rear side of the seat frame suspending between two opposite lateral sides of the seat frame. The bottom bracket is fixedly fastened to the rear wheel frame unit. The swinging frame is pivotally connected between the rear wheel frame unit and the footplate. The footplate is pivotally connected to the swinging frame and turnable with the swinging frame between a first position supportable on the bottom bracket for the standing of a child and a second position supportable on the upper bracket for the sitting of a child.

### BRIEF DESCRIPTION OF THE DRAWINGS

FIG. 1 is a perspective view showing a platform mounting arrangement installed in a frame structure for baby stroller according to the present invention.

FIG. 2 is a schematic drawing of the present invention, showing the footplate turned between the first position and the second position.

FIG. 3 is a sectional view of a part of the present invention, showing the internal structure of the footplate.

FIG. 4 is a top plain view in an enlarged scale of a part of FIG. 3.

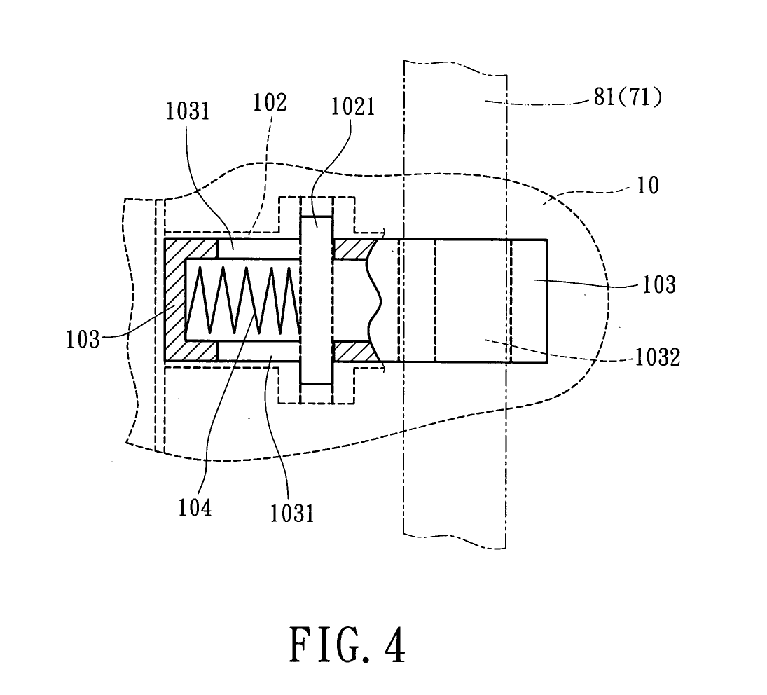

FIG. 5 corresponds to FIG. 3, showing the footplate turned between the first position and the second position.

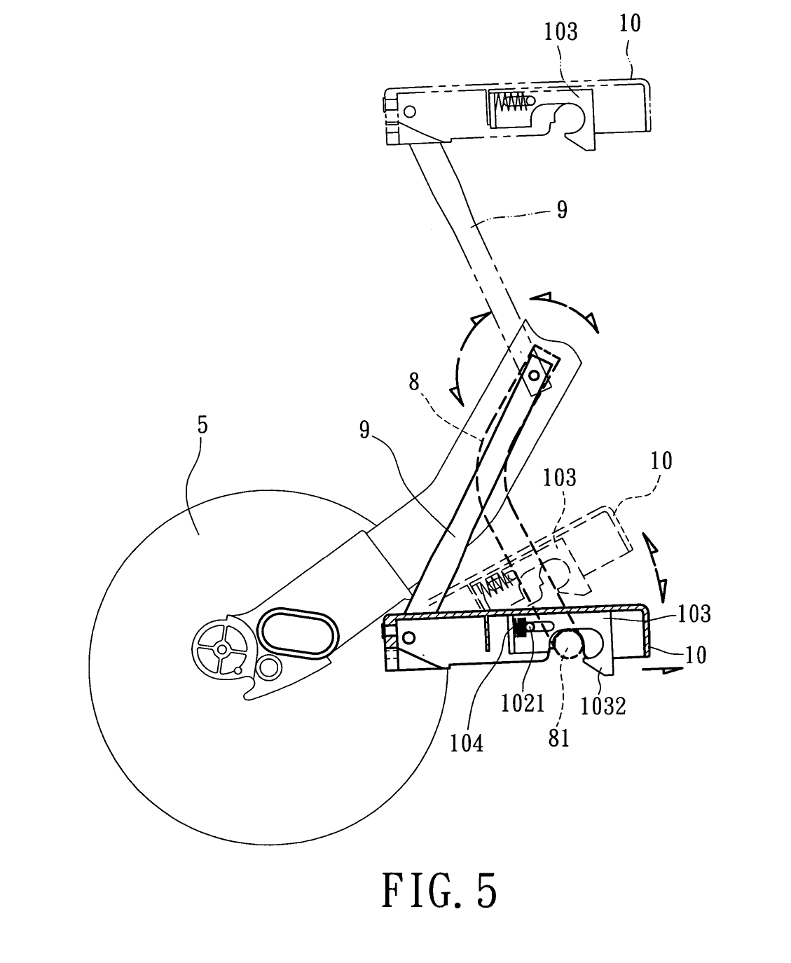

FIG. 6 is a schematic drawing showing the platform mounting arrangement provided with a safety belt according to the present invention.

FIG. 7 is a perspective view of an alternate form of the present the invention.

FIG. 8 corresponds to FIG. 7 but showing the footplate turned to the first position and supported on the supplementary footplate.

### DETAILED DESCRIPTION OF THE PREFERRED EMBODIMENT

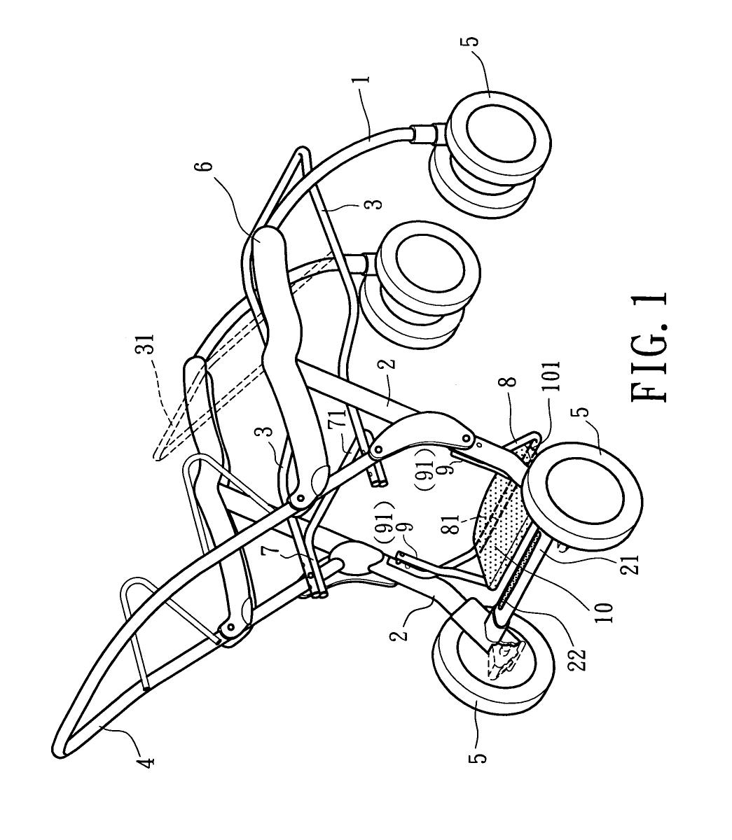

Referring to FIG. 1, a platform mounting arrangement in accordance with the present invention is used in a frame structure for baby stroller. The frame structure for baby stroller is shown comprising a front wheel frame unit 1, a rear wheel frame unit 2, a seat frame 3, a handlebar 4, front and rear wheels 5, and two sidebars 6. The wheels 5 are bilaterally pivotally fastened to the front wheel frame unit 1 and the rear wheel frame unit 2 at the bottom. The two sidebars 6 are bilaterally pivotally connected to the top side of the front wheel frame unit 1 and the top side of the rear wheel frame unit 2. The handlebar 4 is pivotally connected to one end of each of the sidebars 6 and a middle part of the rear wheel frame unit 2. The seat frame 3 comprises a backrest frame tube 31 for supporting a backrest. The platform mounting arrangement of the present invention comprises an upper bracket 7, a bottom bracket 8, a swinging frame 9, and a footplate 10. The upper bracket 7 is a substantially U-shaped frame bar, having two opposite ends thereof horizontally and fixedly fastened to the rear side of the seat frame 3 and a middle bearing portion 71 transversely suspending between two opposite lateral sides of the seat frame 3. The bottom bracket 8 is fixedly fastened to the rear wheel frame unit 2 near the bottom side, having a bearing portion 81 transversely suspending between two opposite lateral sides of the rear wheel frame unit 2. The swinging frame 9 is comprised of two swinging rods 91 each having one end pivotally connected to the rear wheel frame unit 2 and the other end pivotally connected to the rear side of the footplate 10. The footplate 10 has a locating groove 101 transversely provided at the bottom wall near the front side.

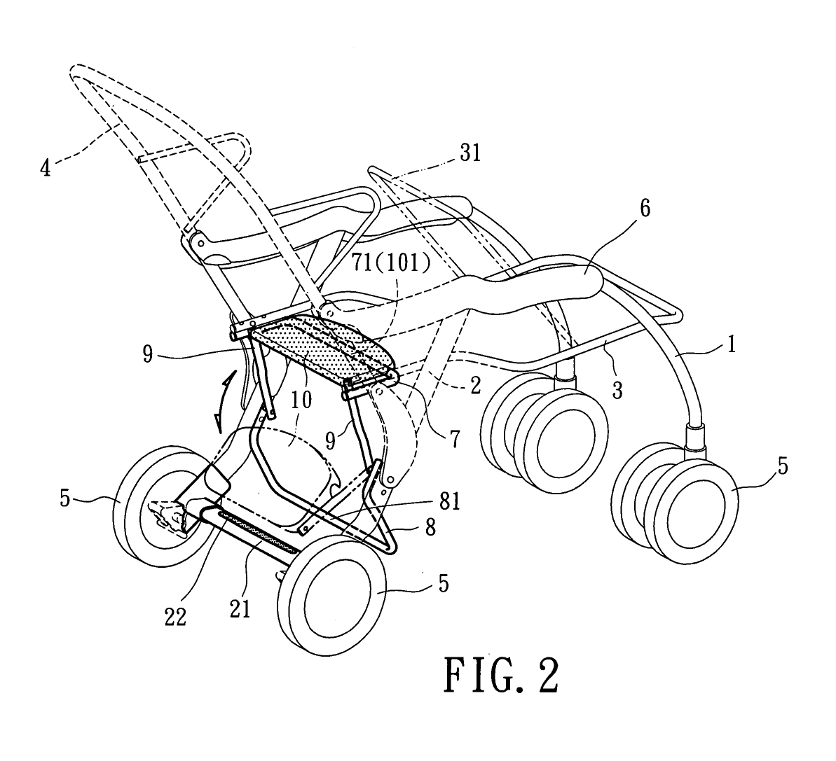

When the swinging frame 9 is turned to the bottom side, the footplate 10 is moved to the first position and supported on the bottom bracket 8 with the bottom locating groove 101 of the footplate 10 set into engagement with the bearing portion 81 of the bottom bracket 8. At this time, as shown in FIG. 1, a child can stand on the footplate 10. When the swinging frame 9 is turned to the top side, the footplate 10 is disengaged from the bottom bracket 8 and moved to the second position with the locating groove 101 set into engagement with the bearing portion 71 of the upper bracket 7. At this time, as shown in FIG. 2, a child can sit on the footplate 10.

Further, the rear wheel frame unit 2 comprises a horizontal foot bar 21 transversely suspended between the two rear wheels 5 and a friction pad 22 fixedly covered on the foot bar 21 for the resting of the feet of the child who sits on the footplate 10 that is set in the second position (see FIGS. 1 and 2).

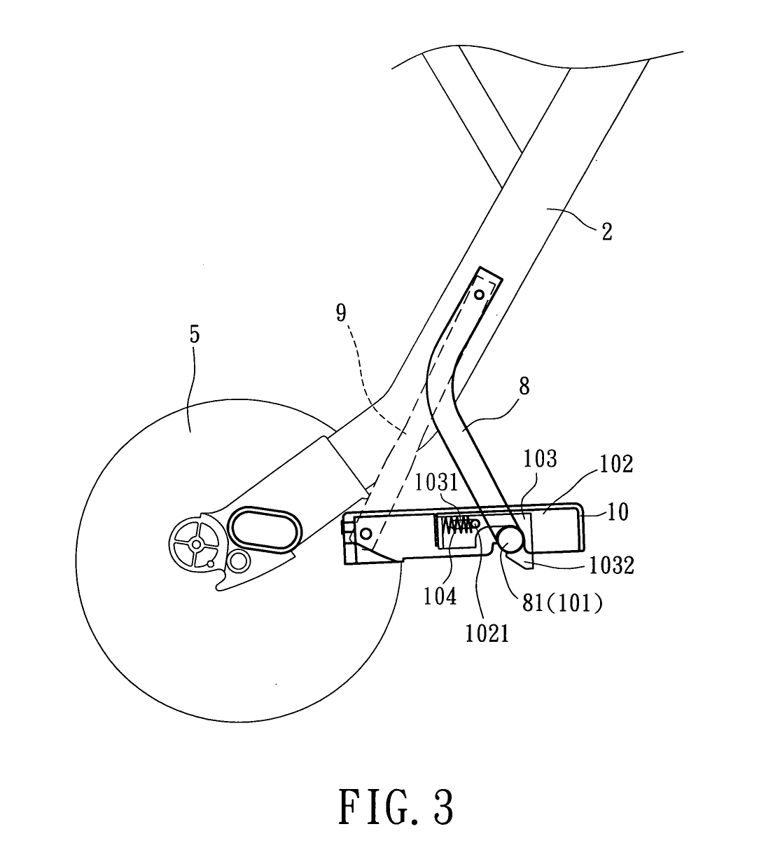

Referring to FIGS. 3˜5, the footplate 10 has an inside chamber 102, a sliding hook 103 axially slidably mounted inside the inside chamber 102 and movable between two positions, namely the locking position and the unlocking position, and a spring member 104 that supports the sliding hook 103 in the locking position. Further, the sliding hook 103 has a longitudinal sliding slot 1031. A pin 1021 is inserted through the longitudinal sliding slot 1031 (see FIUG. 4), The spring member 104 is stopped between a part of the sliding hook 103 and the periphery of the pin 1021 to support the sliding hook 103 in the locking position. The sliding hook 103 has a hooked portion 1032. When the bottom locating groove 101 of the footplate 10 is set into engagement with the bearing portion 81 of the bottom bracket 8 or the bearing portion 71 of the upper bracket 7, the hooked portion 1032 of the sliding hook 103 is forced into engagement with the bearing portion 81 or 71 to lock the footplate 10 (see FIG. 3). When wishing to change the position of the footplate 10, pull the sliding hook 103 outwards to disengage the hooked portion 1032 from the bearing portion 81 of the bottom bracket 8 (or the bearing portion 71 of the upper bracket 7), and therefore the footplate 10 is disconnected from the bottom bracket 8 (or the upper bracket 7).

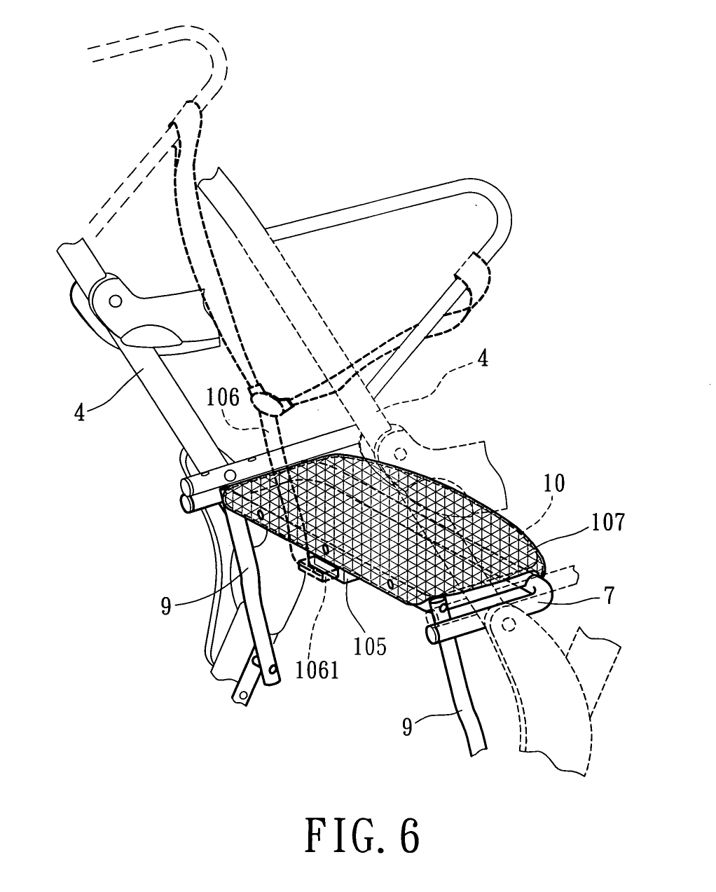

Referring to FIG. 6, the footplate 10 is preferably covered with a cloth covering 107 so that a child can sit on the footplate 10 comfortably. Further, a safety belt 106 is provided for securing the child sitting on the footplate 10. The safety belt 106 has a male buckle member 1061 provided at one end thereof for fastening to a female buckle member 105 that is fixedly provided at the footplate 10.

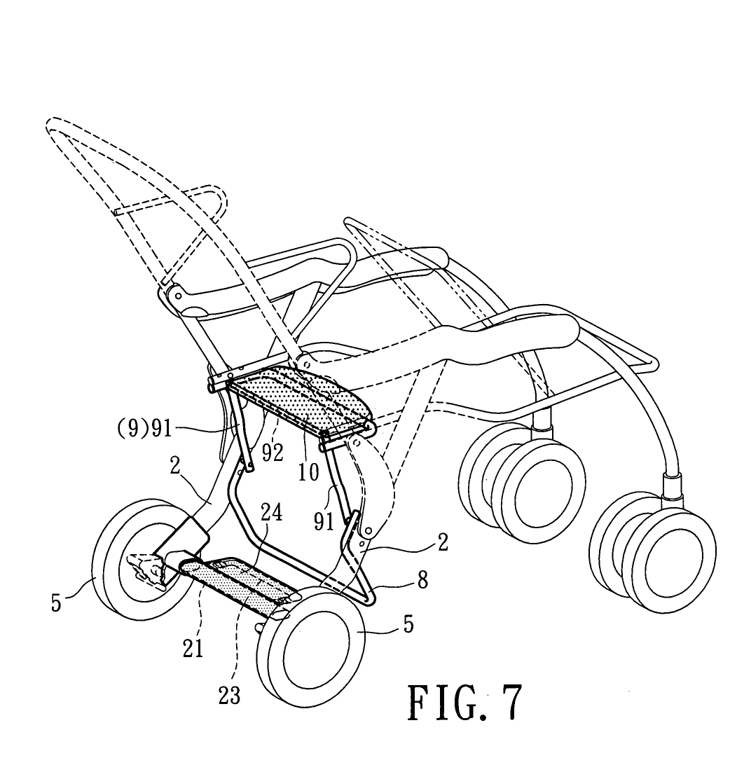

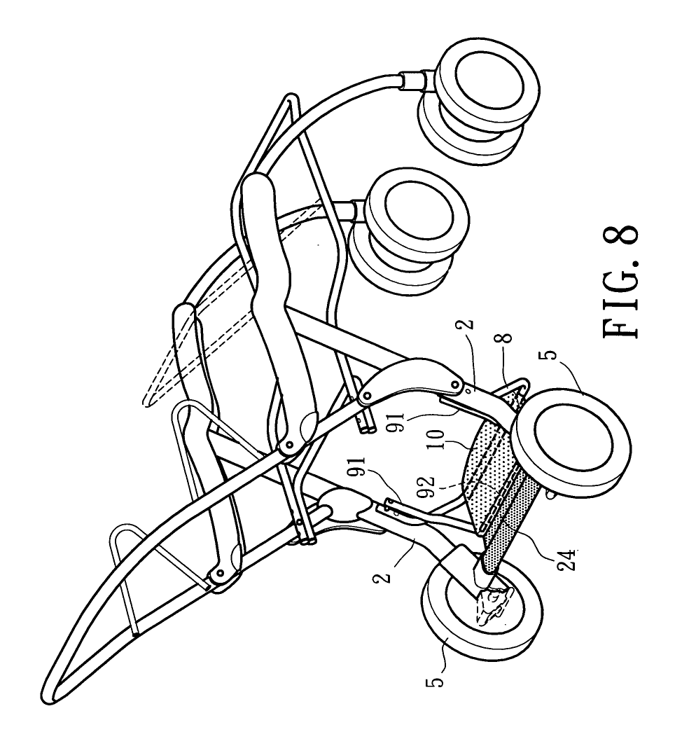

FIGS. 7 and 8 show an alternate form of the present invention. According to this embodiment, the swinging frame 9 is comprised of two swinging rods 91 and a connecting rod 92. The swinging rods 91 each have one end pivotally connected to the rear wheel frame unit 2 and the other end pivotally connected to one end of the connecting rod 92. Further, a support frame 23 is fixedly fastened to the horizontal foot bar 21 of the rear wheel frame unit 2 to support a supplementary footplate 24. When the footplate 10 is set in the second position for the sitting of a child, the child sitting on the footplate 10 can rest the feet on the supplementary footplate 24 (see FIG. 7). When the footplate 10 is set in the first position for the standing of a child, the footplate 10 is supported on the supplementary footplate 24 (see FIG. 8).

Although a particular embodiment of the invention has been described in detail for purposes of illustration, various modifications and enhancements may be made without departing from the spirit and scope of the invention.

What the invention claimed is:

1. A platform mounting structure installed in a frame structure for baby stroller, said frame structure for baby stroller comprising a front wheel frame unit, a rear wheel frame unit, a seat frame, a handlebar, two front wheels, two rear wheels, and two sidebars, the platform mounting arrangement comprising an upper bracket, a bottom bracket, a swinging frame, and a footplate, said upper bracket fixedly fastened to a rear side of said seat frame suspending between two opposite lateral sides of said seat frame, said bottom bracket being fixedly fastened to said rear wheel frame unit, said swinging frame being pivotally connected between said rear wheel frame unit and said footplate, said footplate being pivotally connected to said swinging frame and turnable with said swinging frame between a first position supportable on said bottom bracket for the standing of a child and a second position supportable on said upper bracket for the sitting of a child.

2. The platform mounting structure as claimed in claim 1, wherein said upper bracket and said bottom bracket are respectively formed of a U-shaped frame bar each having a transversely extending middle bearing portion; said footplate has a transversely extending bottom groove, which is forced into engagement with the transversely extending middle bearing portion of said bottom bracket when said footplate is moved to said first position and, which is forced into engagement with the transversely extending middle bearing portion of said upper bracket when said footplate is moved to said second position.

3. The platform mounting structure as claimed in claim 2, wherein said upper bracket is fixedly fastened to the rear side of said seat frame in horizontal.

4. The platform mounting structure as claimed in claim 2, wherein said swinging frame is comprised of two swinging rods each having a first end pivotally connected to said rear wheel frame unit and a second end pivotally connected to a rear side of said footplate,

5. The platform mounting structure as claimed in claim 1, wherein said frame structure for baby stroller further comprises two sidebars bilaterally horizontally coupled between said front wheel frame unit and said rear wheel frame unit at a top side; said handlebar is pivotally connected to one end of each of said sidebars and a middle part of said rear wheel frame unit.

6. The platform mounting structure as claimed in claim 5, wherein said seat frame comprises a backrest frame tube for supporting a backrest.

7. The platform mounting structure as claimed in claim 1, wherein said rear wheel frame unit comprises a horizontal foot bar transversely suspended between said two rear wheels, and a friction pad fixedly covered on the foot bar for the resting of the feet of a child sitting on said footplate.

8. The platform mounting structure as claimed in claim 2, wherein said footplate comprises an inside chamber, a hook member axially slidably mounted inside said inside chamber and movable between a first position where said hook member is hooked on the middle bearing portion of one of said upper bracket and said bottom bracket and a second position where said hook member is disengaged from said upper bracket and said bottom bracket, and a spring member that supports said hook member in said first position.

9. The platform mounting structure as claimed in claim 2, further comprising a safety belt provided at said frame structure for baby stroller, said safety belt comprising a belt buckle for securing a child sitting on said footplate, said belt buckle comprising a female buckle member fixedly provided at said footplate and a male buckle member fixedly provided at one end of said safety belt and connectable to said female buckle member.

10. The platform mounting structure as claimed in claim 2, wherein said footplate is covered with a cloth covering.

11. The platform mounting structure as claimed in claim 8, further comprising a pin transversely coupled to said footplate and said hook member for moving said hook member between said first position and said second position by the user, said pin being inserted through a longitudinal sliding slot at said hook member and stopped against one end of said spring member.

12. The platform mounting structure as claimed in claim 2, wherein said swinging frame comprises two swinging rods each having a first end pivoted to said rear wheel frame unit and a second end, and a connecting rod connected between the second ends of said swinging rods for supporting said footplate.

13. The platform mounting structure as claimed in claim 1, further comprising a horizontal foot bar transversely fastened to said rear wheel frame unit between said two rear wheels, a support frame fixedly fastened to said horizontal foot bar, said a supplementary footplate carried on said support frame.
